(19) United States
(12) Patent Application Publication
(10) Pub. No.: US 2025/0252100 A1
(43) Pub. Date: Aug. 7, 2025

(54) METHOD, APPARATUS, ELECTRONIC DEVICE AND COMPUTER PROGRAM PRODUCT FOR DETERMINING SIMILARITY

(71) Applicant: Beijing Volcano Engine Technology Co., Ltd., Beijing (CN)

(72) Inventors: Yang SUN, Beijing (CN); Yi ZHAN, Beijing (CN); Dongchi HUANG, Beijing (CN); Jiajun XIE, Beijing (CN); Xiaoming YIN, Beijing (CN)

(21) Appl. No.: 19/027,685

(22) Filed: Jan. 17, 2025

(30) Foreign Application Priority Data
Feb. 2, 2024 (CN) 202410154512.7

(51) Int. Cl. G06F 16/2453

(52) U.S. Cl. CPC G06F 16/24532

(57) ABSTRACT

Embodiments of the present disclosure relate to a method, an apparatus, an electronic device, and a computer program product for determining similarity. The method includes obtaining a first program statement and a second program statement. The method also includes generating a first heterogeneous diagram corresponding to the first program statement and a second heterogeneous diagram corresponding to the second program statement. In addition, the method also includes determining the similarity between the first program statement and the second program statement based on the first heterogeneous diagram and the second heterogeneous diagram. Therefore, with the solution proposed in the embodiments of the present disclosure, a program statement can be converted into a heterogeneous diagram to calculate similarity through heterogeneous diagram matching.

### CROSS-REFERENCE TO RELATED APPLICATION(S)

This application claims priority to Chinese Application No. 202410154512.7 filed in Feb. 2, 2024, the disclosure of which are incorporated herein by reference in its entirety.

### FIELD

Embodiments of the present disclosure relate to the field of computers, and more specifically, to a method, an apparatus, an electronic device, and a computer program product for determining similarity.

### BACKGROUND

Natural language to program statement technologies, for example, Text-to-SQL (structured query language) technologies, are developing faster and faster. Text-to-SQL greatly simplifies a data query process by converting a natural language into a database query language, so that a non-technical person can easily interact with a database. This not only improves the efficiency of in-house development of enterprises, but also broadens the range of participants in the field of data science, so that more people can intuitively make complex queries, and promotes the popularization and practice of data-driven decision-making.

In the natural language to program language technology, the importance of determining similarity between program statements cannot be ignored. Accurately determining similarity can effectively optimize a conversion process from a natural language to a program statement, and improve the capability of a system to understand a user's intention. This is crucial for handling diverse expressions and grammatical structures. Especially in terms of diversity and flexibility of questions from users, corresponding program statements can be generated more accurately.

### SUMMARY

Embodiments of the present disclosure provide a method, an apparatus, an electronic device, a computer program product, and a medium for determining similarity.

According to a first aspect of the present disclosure, a method for determining similarity is provided. The method includes obtaining a first program statement and a second program statement. The method also includes generating a first heterogeneous diagram corresponding to the first program statement and a second heterogeneous diagram corresponding to the second program statement. The first heterogeneous diagram and the second heterogeneous diagram represent a plurality of statement tokens in the first program statement and the second program statement and relationships between the plurality of statement tokens, respectively. In addition, the method also includes determining the similarity between the first program statement and the second program statement based on the first heterogeneous diagram and the second heterogeneous diagram.

According to a second aspect of the present disclosure, an apparatus for determining similarity is provided. The apparatus includes a statement obtaining unit configured to obtain a first program statement and a second program statement. The apparatus also includes a heterogeneous diagram generation unit configured to generate a first heterogeneous diagram corresponding to the first program statement and a second heterogeneous diagram corresponding to the second program statement. The first heterogeneous diagram and the second heterogeneous diagram represent a plurality of statement tokens in the first program statement and the second program statement and relationships between the plurality of statement tokens, respectively. In addition, the apparatus also includes a similarity determination unit configured to determine similarity between the first program statement and the second program statement based on the first heterogeneous diagram and the second heterogeneous diagram.

According to a third aspect of the present disclosure, an electronic device is provided. The electronic device includes a processor and a memory coupled to the processor. The memory has instructions stored therein. The instructions, when executed by the processor, cause the electronic device to perform the method according to the first aspect.

In a fourth aspect of the present disclosure, a computer program product is provided. The computer program product is tangibly stored on a non-transitory computer readable medium and includes machine executable instructions. The machine executable instructions, when executed, cause a machine to perform the method according to the first aspect.

In a fifth aspect of the present disclosure, a computer readable storage medium is provided. The computer readable storage medium has one or more computer instructions stored thereon. The one or more computer instructions are executed by a processor to implement the method according to the first aspect.

The summary is intended to introduce a selection of concepts in a simplified form, which will be further described in the following detailed description. The summary is not intended to identify key features or essential features of the subject matter claimed, nor is it intended to limit the scope of the subject matter claimed.

### BRIEF DESCRIPTION OF THE DRAWINGS

The above and other features, advantages, and aspects of various embodiments of the present disclosure become more apparent with reference to the following detailed description and in conjunction with the drawings. Throughout the drawings, the same or similar reference numbers refer to the same or similar elements, where:

FIG. 1 is a schematic diagram of an example environment in which a method according to an embodiment of the present disclosure may be implemented;

FIG. 2 is a flowchart of a method for determining similarity according to an embodiment of the present disclosure;

FIG. 3A is a flowchart of a process of generating a program heterogeneous diagram according to an embodiment of the present disclosure;

FIG. 3B is a schematic diagram of a program heterogeneous diagram according to an embodiment of the present disclosure;

FIG. 4 is a schematic diagram of an example of training a heterogeneous diagram matching model according to an embodiment of the present disclosure;

FIG. 5 is a schematic diagram of a process of node encoding according to an embodiment of the present disclosure;

FIG. 6 is a block diagram of an apparatus for determining similarity according to some embodiments of the present disclosure; and

FIG. 7 is a block diagram of an electronic device according to some embodiments of the present disclosure.

Throughout the drawings, the same or similar reference numbers refer to the same or similar elements.

### DETAILED DESCRIPTION OF EMBODIMENTS

It should be understood that data involved in the technical solution of the present disclosure (including but not limited to the data itself, and the acquisition or use of the data) should comply with requirements of corresponding laws, regulations, and relevant provisions.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and the embodiments of the present disclosure are only for illustrative purposes and are not intended to limit the scope of protection of the present disclosure.

In the description of the embodiments of the present disclosure, the term “include/include” and similar terms should be understood as open-ended inclusions, that is, “include/include but not limited to”. The term “based on” should be understood as “at least partially based on”. The term “one embodiment” or “this embodiment” should be understood as “at least one embodiment”. The terms “first”, “second”, and the like may refer to different or the same objects, unless explicitly stated. The following may also include other explicit and implicit definitions.

As mentioned above, determining similarity between program statements is of great significance to the natural language to program language technology and other related technologies. In related technologies for determining program statements, similarity is usually determined for outputs of different program statements, or similarity is determined based on element matching in the program statements. These related technologies do not use structural and hierarchical information of program statements, and lack the capability of capturing internal execution logic and data calculation processes of the program statements.

To this end, the embodiments of the present disclosure provide a solution for determining similarity. The solution may obtain a first program statement and a second program statement, and generate a first heterogeneous diagram corresponding to the first program statement and a second heterogeneous diagram corresponding to the second program statement. The first heterogeneous diagram and the second heterogeneous diagram respectively represent a plurality of statement tokens in the first program statement and the second program statement and relationships between the plurality of statement tokens. The similarity between the first program statement and the second program statement is then determined according to the first heterogeneous diagram and the second heterogeneous diagram.

Therefore, with the solution proposed in the embodiments of the present disclosure, a program statement can be converted into a heterogeneous diagram to calculate similarity through heterogeneous diagram matching. Not only element matching is concerned, but also the syntactic and structural features of the program statement are considered in combination, so that the internal logic and data processing flow of the program statement can be understood and evaluated more precisely, and the accuracy and efficiency of program statement similarity calculation are improved.

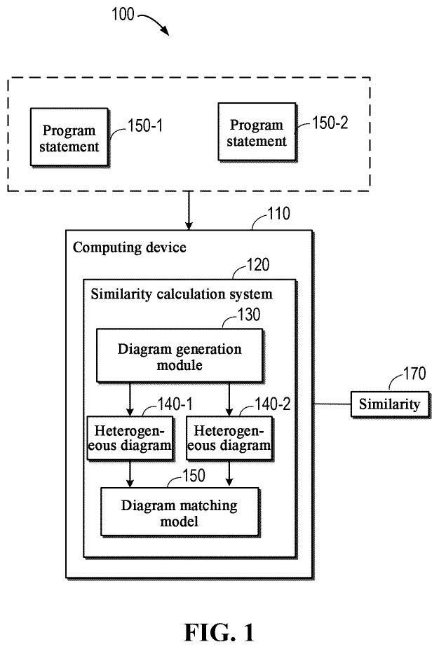

FIG. 1 is a schematic diagram of an example environment 100 in which a method according to an embodiment of the present disclosure may be implemented. As shown in FIG. 1, the example environment 100 may include a program statement 150-1 and a program statement 150-2 (which may hereinafter be individually or collectively referred to as program statements 150). In some embodiments, the program statement 150 may be a structured query language (SQL) statement. In addition, the program statement 150 may be other types of languages, such as Java, Python, or C, and the present disclosure is not limited thereto. In some embodiments, the program statement 150-1 and the program statement 150-2 may be different types of program statements, for example, the program statement 150-1 is Python and the program statement 150-2 is Java, or other possible combinations.

Referring to FIG. 1, the example environment 100 may include a computing device 110. The computing device 110 may be a user terminal, a mobile device, a computer, etc., and may also be a computing system, a single server, a distributed server, or a cloud-based server. In some embodiments, the computing device 110 may receive the program statement 150-1 and the program statement 150-2 to calculate similarity between the two. The computing device 110 may include a similarity calculation system 120. For example, the similarity calculation system 120 may be deployed in the computing device 110. The similarity calculation system 120 may receive a plurality of program statements and determine similarity between the plurality of program statements. The similarity may be in the form of any numerical value ranging from 0 to 1, or may be in a rating form ranging from 0 to 5 (e.g., 0 represents the least similarity, and 5 represents the most similarity, and so on), which is not limited in the present disclosure.

Continuing to refer to FIG. 1, the similarity calculation system 120 may include a diagram generation module 130, and a heterogeneous diagram 140-1 and a heterogeneous diagram 140-2 (which may hereinafter be individually or collectively referred to as heterogeneous diagrams 140). The diagram generation module 130 may convert the program statement 150 into a program heterogeneous diagram. For example, the diagram generation module 130 may convert the program statement 150-1 into the heterogeneous diagram 140-1, and may also convert the program statement 150-2 into the heterogeneous diagram 140-1. In some embodiments, a diagram matching model 150 may be used to calculate similarity 170 between the heterogeneous diagram 140-1 and the heterogeneous diagram 140-1.

It should be understood that the architecture and functions in the example environment 100 are described for illustrative purposes only, without implying any limitation on the scope of the present disclosure. The embodiments of the present disclosure may also be applied to other environments with different structures and/or functions.

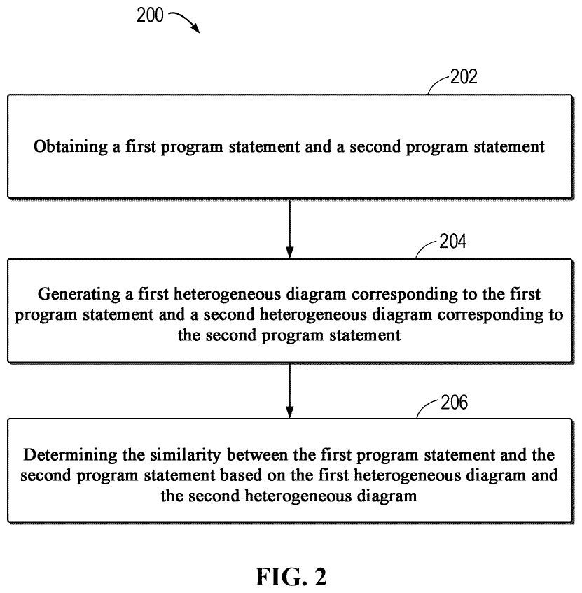

The process according to the embodiments of the present disclosure will be described in detail below with reference to FIGS. 2 to 7. For ease of understanding, specific data mentioned in the following description is exemplary and is not intended to limit the scope of protection of the present disclosure. It should be understood that the embodiments described below may also include additional actions not shown and/or may omit the shown actions, and the scope of the present disclosure is not limited in this aspect.

FIG. 2 is a flowchart of a method 200 for determining similarity according to an embodiment of the present disclosure. At block 202, a first program statement and a second program statement may be obtained. For example, as shown in FIG. 1, the similarity calculation system 120 may obtain the program statement 150-1 and the program statement 150-2.

At block 204, a first heterogeneous diagram corresponding to the first program statement and a second heterogeneous diagram corresponding to the second program statement may be generated. The first heterogeneous diagram and the second heterogeneous diagram represent a plurality of statement tokens in the first program statement and the second program statement and relationships between the plurality of statement tokens, respectively. For example, as shown in FIG. 1, the similarity calculation system 120 may generate a heterogeneous diagram 140-1 corresponding to the program statement 150-1 and a heterogeneous diagram 140-2 corresponding to the program statement 150-2. The heterogeneous diagram 140-1 and the heterogeneous diagram 140-2 represent a plurality of statement tokens in the program statement 150-1 and the program statement 150-2 and relationships between the plurality of statement tokens, respectively.

At block 204, similarity between the first program statement and the second program statement may be determined based on the first heterogeneous diagram and the second heterogeneous diagram. For example, as shown in FIG. 1, the similarity calculation system 120 may determine similarity 170 between the program statement 150-1 and the program statement 150-1 based on the heterogeneous diagram 140-1 and the heterogeneous diagram 140-1.

Therefore, with the method 200 provided in the embodiments of the present disclosure, a program statement can be converted into a heterogeneous diagram to calculate similarity through heterogeneous diagram matching. Not only element matching is concerned, but also the syntactic and structural features of the program statement are considered in combination, so that the internal logic and data processing flow of the program statement can be understood and evaluated more precisely, and the accuracy and efficiency of program statement similarity calculation are improved.

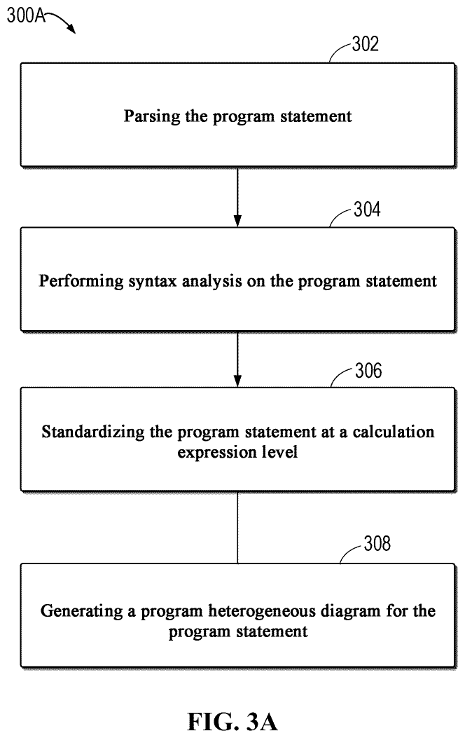

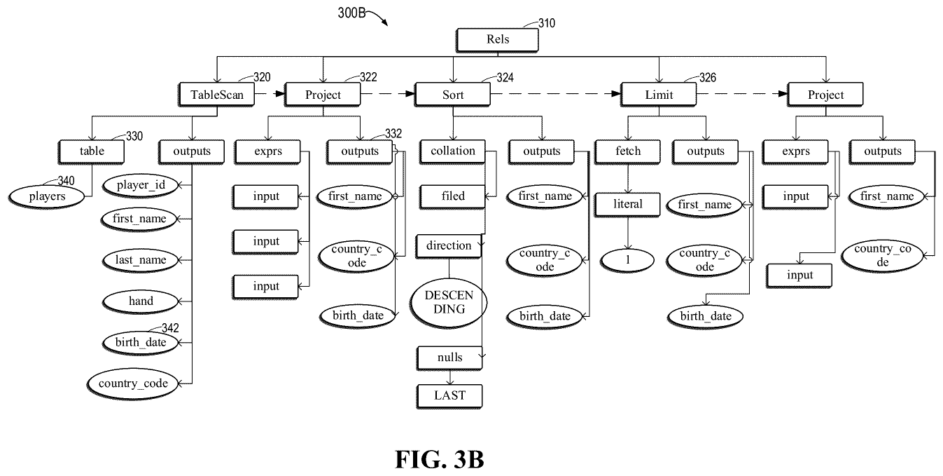

FIG. 3A is a flowchart of a process 300A of generating a program heterogeneous diagram according to an embodiment of the present disclosure. FIG. 3B is a schematic diagram of a program heterogeneous diagram 300B according to an embodiment of the present disclosure. The process 300A in FIG. 3A will be described below with reference to FIG. 3B. As shown in FIG. 3A, at block 302, a program statement may be parsed. For example, referring to FIG. 1, the diagram generation module 130 may parse the program statement 150-1. During the parsing process, the program statement may be lexically analyzed and decomposed into a series of statement tokens (tokens), which are basic building blocks of the grammar corresponding to the program statement. For example, the program statement may be a SQL statement “SELECT first_name, country_code FROM players ORDER BY birth_date desc LIMIT 1”. By parsing the SQL statement, keywords such as “SELECT” and “FROM” may be obtained; identifiers such as a table name “players” and a column name “first_name” may be obtained; operators such as “+” and “−” may be obtained; and literal values such as numbers and strings may be obtained.

At block 304, the program statement may be syntactically analyzed. For example, still referring to the above SQL statement, during syntactic analysis, SQL syntax rules may be used to determine the relationships and structures between statement tokens, to indicate how the statement structures are combined to form a legal and meaningful SQL statement. The purpose of the syntax analysis is to construct an abstract syntax tree that reflects the structure of the SQL statement. The abstract syntax tree may hierarchically represent the structure of the SQL statement. In the abstract syntax tree, each node represents a component of the SQL statement. For example, a node may represent an entire SELECT clause, and a child node may represent a specific field or table name therein.

At block 306, the program statement may be standardized at a calculation expression level. For example, still referring to the above SQL statement, the SQL statement may be converted into a logical plan, which is an ordered set of operations that may be used to implement the calculation of the SQL statement. The logical plan may be used for query rewriting. For example, the order of conditions in a WHERE clause may be rearranged, so that the most selective conditions are checked first. The calculation of redundant clauses may also be eliminated, for example, meaningless nested subqueries may be removed. In addition, an optimal table join order may also be selected in a query involving multiple tables.

When comparing the semantic similarity between two SQL statements, this standardization may reduce interference caused by superficial grammatical differences, and focus more on comparing the essential structures and logic of the queries. The optimization process converts different SQL statements into a more standardized and compact form by eliminating redundant and unnecessary parts, thereby simplifying the similarity comparison process and improving its accuracy. In addition, the standardization focuses not only on the structure of the SQL statement, but also on its underlying execution path. Therefore, standardizing the program statement at the calculation expression level may not only assess the similarity of the structure, but also the similarity of execution logic and efficiency. Therefore, similar logical relationships hidden under different grammatical expressions may be revealed more effectively, thereby obtaining more accurate and meaningful results when performing in-depth analysis and comparison of SQL statements.

At block 308, a program heterogeneous diagram of the program statement may be generated. An example form of the program heterogeneous diagram will be described below with reference to FIG. 3B. In some embodiments, the plurality of statement tokens and the relationships between the plurality of statement tokens are determined by parsing the first program statement. In some embodiments, a set of ordered operations is determined based on an execution sequence of the first program statement. In addition, in some embodiments, the first heterogeneous diagram is determined based on the plurality of statement tokens, the relationships, and the set of ordered operations.

Referring to FIG. 3B, the program heterogeneous diagram 300B is an abstract syntax tree obtained by processing the SQL statement “SELECT first_name, country_code FROM players ORDER BY birth_date desc LIMIT 1” according to the process 300A. As shown in FIG. 3B, square nodes therein are computing nodes, and elliptical nodes are content nodes. The computing nodes may establish a grammatical framework and a hierarchical structure of the SQL query, and mainly represent keywords in the SQL. For example, the second layer of the program heterogeneous diagram 300B includes a TableScan node 320, a Sort node 324, and a Limit node 326, which correspond to the FROM, ORDER BY, and LIMIT clauses in the SQL statement, respectively. In addition, the Project node 322 in the second layer and the outputs node 332 in the third layer are introduced based on the execution logic of the SQL, and are used to specify a specific data access path.

In addition, the content nodes are leaf nodes of the abstract syntax tree, representing specific variables and parameters in the SQL statement. For example, in a sub-tree of the TableScan node 320, a player node 340 under a table node 330 represents a target table name of the query. In some embodiments, in addition to the abstract syntax tree, data flow and logical flow may also be used to more comprehensively capture and analyze the grammatical and semantic relationships between the SQL queries. For example, dotted lines between the computing nodes in the second layer represent the logical flow, and these computing nodes represent a set of ordered operations, indicating a logical order of the execution of clauses. For example, the execution starts from the FROM query, then the Sort and Limit are executed, and finally the required fields are output through the SELECT statement. In some embodiments, data flow may be used to move data in the SQL query. For example, the outputs of the TableScan extracts birth_data from the table and introduces it into the Project operation. Subsequently, it is output as a field required by the Sort operation under the outputs of the Sort and Limit in the execution order. Therefore, the program statement will be constructed as a heterogeneous program heterogeneous diagram that integrates various grammars and semantics.

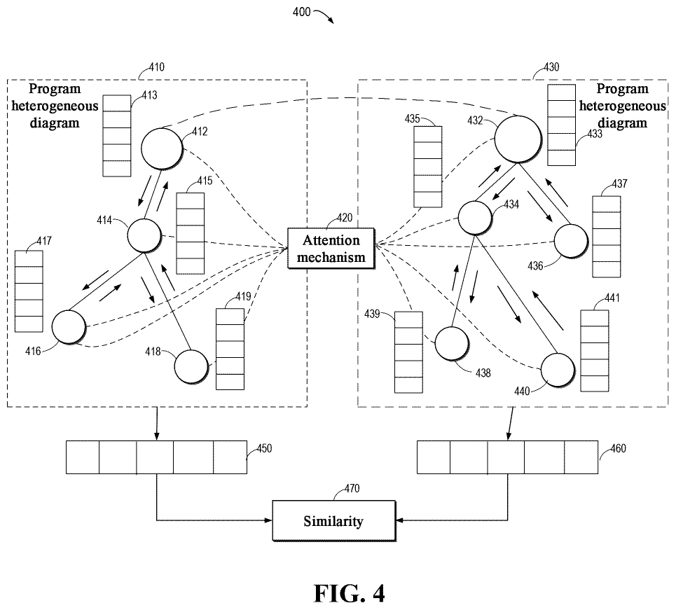

FIG. 4 is a schematic diagram of an example 400 of training a heterogeneous diagram matching model according to an embodiment of the present disclosure. As shown in FIG. 4, the diagram matching model processes a program heterogeneous diagram 410 and a program heterogeneous diagram 430 (the program heterogeneous diagram 300B as shown in FIG. 3B). The program heterogeneous diagram 410 may include a node 412, a node 414, a node 416, and a node 418, where the node 412 may be a root node of the program heterogeneous diagram 40. Four nodes are shown here for illustrative purposes, and in fact the program heterogeneous diagram may include fewer or more nodes. The program heterogeneous diagram 430 may include a node 432, a node 434, a node 436, a node 438, and a node 440, where the node 432 may be a root node of the program heterogeneous diagram 430.

In the program heterogeneous diagram 410, straight arrows between the nodes may represent information transfer inside the program heterogeneous diagram, and the information transfer inside the program heterogeneous diagram may be represented by formula (1):

$${m}_{j \to i} = {f}_{message} ( {h}_{i}^{( t )} , {h}_{j}^{( t )} , {e}_{ij} ) , ∀ ( i , j ) ∈ {E}_{1} ⋃ {E}_{2} \qquad ( 1 )$$

where ƒ_{message} represents information transfer between nodes in a single diagram through edges, and h represents feature information of the nodes themselves or node embeddings.

In addition to the node feature information h, a position encoding p of a joint large diagram is also introduced. In some embodiments, the root node 412 of the program heterogeneous diagram 410 may be connected to the root node 430 of the program heterogeneous diagram 430, and a probability vector of a node returning to its own node after k random walks from the root node is taken as its position embedding (also referred to as position encoding) using random walks, so as to better measure a matching degree of the node in the program heterogeneous diagram with all nodes in another program heterogeneous diagram. As shown in FIG. 4, in the program heterogeneous diagram 410, a position embedding 413 is a position embedding of the node 412, a position embedding 415 is a position embedding of the node 414, a position embedding 417 is a position embedding of the node 416, and a position embedding 419 is a position embedding of the node 418. In addition, in the program heterogeneous diagram 430, a position embedding 433 is a position embedding of the node 432, a position embedding 435 is a position embedding of the node 434, a position embedding 437 is a position embedding of the node 436, a position embedding 439 is a position embedding of the node 438, and a position embedding 441 is a position embedding of the node 440.

In addition, an attention mechanism 420 is introduced into the diagram matching neural network. The attention mechanism 420 may capture interaction relationships between the program heterogeneous diagram 410 and the program heterogeneous diagram 430, and jointly calculate similarity between the two, instead of only focusing on isolated characteristics between each program heterogeneous diagram. The attention mechanism 420 may more accurately reflect similarity or differences between two program heterogeneous diagrams. Weight information in the attention mechanism 420 may be calculated by formula (2):

$${a}_{j \to i} = \frac{exp ( {s}_{x} ( {x}_{i}^{( t )} , {x}_{j}^{( t )} ) )}{{\sum }_{{j}^{′}} exp ( {s}_{x} ( {x}_{i}^{( t )} , {x}_{j}^{( t )} ) )} \qquad ( 2 )$$

where sₓ is an algorithm for calculating similarity between two vectors, for example, vector dot product calculation. xᵢ^{(t)} is obtained by the node feature h and the position embedding p, as shown in formula (3):

$${x}_{i}^{( t )} = MLP ( {h}_{i}^{( t )} ⊕ {p}_{i}^{( t )} ) \qquad ( 3 )$$

After the weight information of the attention mechanism 420 is obtained, a function ƒ_{match} for transferring cross-diagram information between the program heterogeneous diagram 410 and the program heterogeneous diagram 430 may be calculated, which may be represented by formula (4):

$${μ}_{j \to i} = {f}_{match} ( {x}_{i}^{( t )} , {x}_{j}^{( t )} ) , i ∈ {V}_{1} , j ∈ {V}_{2} , or i ∈ {V}_{2} , j ∈ {V}_{1} \qquad ( 4 )$$

Based on the above description, an update formula for node features is obtained, as shown in formula (5):

$${h}_{i}^{( t + 1 )} = {f}_{node} ( {h}_{i}^{( t )} , {\sum }_{j} {m}_{j \to i} , {\sum }_{{j}^{′}} {μ}_{{j}^{′} - i} ) \qquad ( 5 )$$

Then, a diagram embedding 450 may be generated by aggregating node features of all the nodes in the program heterogeneous diagram 410; and a diagram embedding 460 may be generated by aggregating node features of all the nodes in the program heterogeneous diagram 430. As shown in formula (6) and formula (7):

$${h}_{{G}_{1}} = {f}_{G} ( {\{ {h}_{i}^{( T )} \}}_{i ∈ {V}_{1}} ) \qquad ( 6 )$$

$${h}_{{G}_{2}} = {f}_{G} ( {\{ {h}_{i}^{( T )} \}}_{i ∈ {V}_{2}} ) \qquad ( 7 )$$

where an aggregation function ƒ_{G} may be a summation function or an averaging function.

Finally, a vector similarity algorithm is used to calculate the similarity 470 between the two vectors, with reference to formula (8):

$$s = {f}_{s} ( {h}_{{G}_{1}} , {h}_{{G}_{2}} ) \qquad ( 8 )$$

where the similarity function ƒₛ may be vector dot product calculation, etc., which is not limited in the present disclosure. In some embodiments, the similarity 470 may be a predicted similarity, and the heterogeneous diagram matching model may be trained with a similarity label and the similarity 470. The similarity label may be a label value of similarity between a program statement corresponding to the program heterogeneous diagram 410 and a program statement corresponding to the program heterogeneous diagram 420.

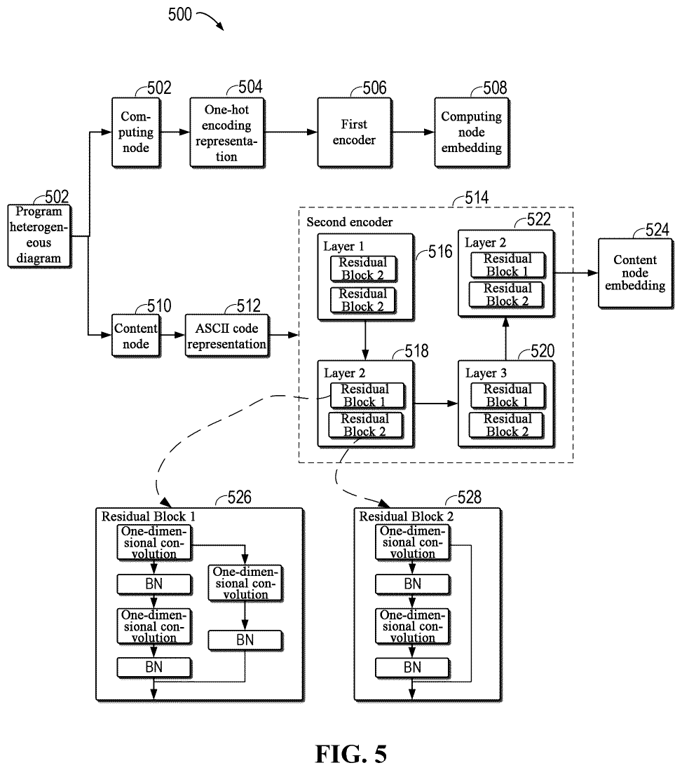

FIG. 5 is a schematic diagram of a process 500 of node encoding according to an embodiment of the present disclosure. As shown in FIG. 5, a program heterogeneous diagram 502 may include a computing node 502 and a content node 510. Since the computing node 502 and the content node 510 have different grammatical meanings and perform different functions, the computing node 502 and the content node 510 may be encoded and characterized using different methods. For example, in the SQL grammar structure, there may be many structurally equivalent expressions, such as “ORDER BY” in combination with “LIMIT” may function similarly to “MAX” and “MIN”. Therefore, for the computing node 502, it is possible to focus on the interaction and overall structure of the computing node, rather than just the type characteristics of the node itself. In some embodiments, one-hot encoding may be used to encode the computing node 510 into a one-hot encoding representation. For example, MAX is encoded in the form of one-hot encoding of [1, 0, 0, 0]. Then, a node embedding 508 of the computing node may be determined using a first encoder 506. In some embodiments, the first encoder 506 may be a multi-layer perceptron MLP. In addition, the first encoder 506 may also be a neural network of other structures, which is not limited in the present disclosure. The node embedding 508 of the computing node may be input to the computing node of the program heterogeneous diagram 410 in FIG. 4 to represent feature information of the corresponding computing node.

Continuing to refer to FIG. 5, different from the computing node 502, the content node 510 is a leaf node of the abstract syntax tree, reflecting the parameter variables in the SQL. Therefore, even if the grammatical structures are the same, if the parameter variables involved are different, for example, different table names or different column names are selected, two completely unrelated SQL statements may be obtained. Therefore, for the content node 510, more attention is paid to its own feature information. Different from the natural language, the parameters and variables of the program language do not have semantic diversity. For example, “Kid” and “Child” refer to two completely different parameters, so it is not suitable to use a conventional word embedding model to characterize the content node 510. In some embodiments, an ASCII code representation 512 of the content node 510 may be generated. Then, a content node embedding 524 is generated through a second encoder 514. The content node embedding 524 may be input to the content node of the program heterogeneous diagram 410 in FIG. 4 to represent feature information of the corresponding computing node.

The second encoder 514 may include a layer 1 516, a layer 2 518, a layer 3 520, and a layer 4 522. Each layer may include a residual block 1 and/or a residual block 2 to implement encoding of the ASCII code representation 512. In some embodiments, the residual block 1 may be implemented as a residual block 526 and the residual block 2 may be implemented as a residual block 528, where 1-dimensional convolutional layers and residual blocks, which facilitates solving the problem of gradient disappearance in deeper networks and improving the capability of feature learning.

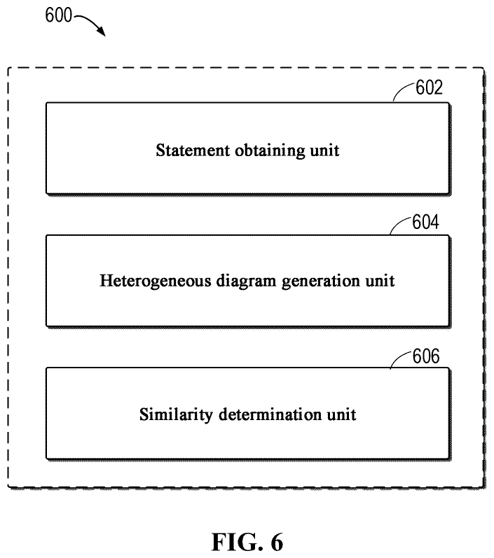

FIG. 6 is a block diagram of an apparatus 600 for determining similarity according to some embodiments of the present disclosure. As shown in FIG. 6, the apparatus 600 includes a statement obtaining unit 602 configured to obtain a first program statement and a second program statement. The apparatus 600 also includes a heterogeneous diagram generation unit 604 configured to generate a first heterogeneous diagram corresponding to the first program statement and a second heterogeneous diagram corresponding to the second program statement. The first heterogeneous diagram and the second heterogeneous diagram represent a plurality of statement tokens in the first program statement and the second program statement and relationships between the plurality of statement tokens, respectively. In addition, the apparatus 600 also includes a similarity determination unit 606 configured to determine similarity between the first program statement and the second program statement based on the first heterogeneous diagram and the second heterogeneous diagram.

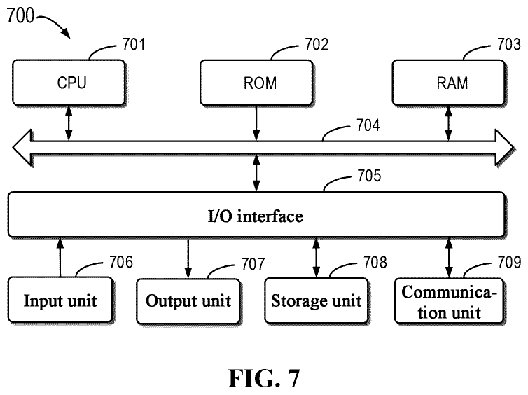

FIG. 7 is a block diagram of an electronic device 700 according to some embodiments of the present disclosure. FIG. 7 shows a block diagram of an electronic device 700 according to some embodiments of the present disclosure. The device 700 may be a device or apparatus described in the embodiments of the present disclosure. As shown in FIG. 7, the device 700 includes a central processing unit (CPU) and/or a graphics processing unit (GPU) 701 that may perform various appropriate actions and processes according to computer program instructions stored in a read-only memory (ROM) 702 or computer program instructions loaded from a storage unit 708 into a random access memory (RAM) 703. Various programs and data required for operations of the device 700 may also be stored in the RAM 703. The CPU/GPU 701, the ROM 702, and the RAM 703 are connected to each other through a bus 704. An input/output (I/O) interface 705 is also connected to the bus 704. Although not shown in FIG. 7, the device 700 may also include a coprocessor.

Multiple components in the device 700 are connected to the I/O interface 705, including: an input unit 706 such as a keyboard, a mouse, or the like; an output unit 707 such as various types of displays, speakers, or the like; a storage unit 708 such as a magnetic disk, an optical disk, or the like; and a communication unit 709 such as a network card, a modem, a wireless communication transceiver, or the like. The communication unit 709 allows the device 700 to exchange information/data with other devices through a computer network such as the Internet and/or various telecommunication networks.

The various methods or processes described above may be performed by the CPU/GPU 701. For example, in some embodiments, the method may be implemented as a computer software program, which is tangibly contained in a machine readable medium, such as the storage unit 708. In some embodiments, part or all of the computer program may be loaded into and/or installed on the device 700 via the ROM 702 and/or the communication unit 709. When the computer program is loaded into the RAM 703 and executed by the CPU/GPU 701, one or more steps or actions of the method or process described above may be performed.

In some embodiments, the method and process described above may be implemented as a computer program product. The computer program product may include a computer-readable storage medium having computer-readable program instructions for performing various aspects of the present disclosure.

The computer-readable storage medium may be a tangible device that can hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, such as a punched card or a groove raised structure with instructions stored thereon, and any suitable combination thereof. The computer-readable storage medium as used herein is not interpreted as a transient signal per se, such as radio waves or other freely propagating electromagnetic waves, electromagnetic waves propagating through waveguides or other transmission media (for example, light pulses through fiber optic cables), or electrical signals transmitted through wires.

The computer-readable program instructions described herein may be downloaded from a computer-readable storage medium to various computing/processing devices, or downloaded to an external computer or an external storage device through a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or a network interface in each computing/processing device receives computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages, as well as conventional procedural programming languages. The computer-readable program instructions may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider). In some embodiments, the electronic circuit, such as a programmable logic circuit, a field programmable gate array (FPGA) or a programmable logic array (PLA), may be customized with state information of the computer-readable program instructions, and the electronic circuit may perform the computer-readable program instructions, so as to implement various aspects of the present disclosure.

These computer-readable program instructions may be provided to a processing unit of a general-purpose computer, special-purpose computer or other programmable data processing apparatus to produce a machine, such that the instructions, when executed by the processing unit of the computer or other programmable data processing apparatus, implement the functions/acts specified in one or more blocks of the flowcharts and/or block diagrams. These computer-readable program instructions may also be stored in a computer-readable storage medium. These instructions cause a computer, a programmable data processing apparatus and/or other devices to work in a specific way, so that the computer-readable medium having instructions stored therein includes an article of manufacture, which includes instructions for implementing various aspects of the functions/acts specified in one or more blocks of the flowcharts and/or block diagrams.

The computer-readable program instructions may also be loaded onto a computer, other programmable data processing apparatuses, or other devices, causing a series of operational steps to be performed on the computer, other programmable data processing apparatuses, or other devices to produce a computer-implemented process, such that the instructions executed on the computer, other programmable data processing apparatuses, or other devices implement the functions/acts specified in one or more blocks of the flowcharts and/or block diagrams.

The flowcharts and block diagrams in the drawings show possible architectures, functions, and operations of the device, method, and computer program product according to multiple embodiments of the present disclosure. In this point, each block in the flowcharts or block diagrams may represent a module, a program segment, or a part of instructions, and the module, the program segment, or the part of instructions contains one or more executable instructions for implementing a specified logical function. In some alternative implementations, the functions marked in the blocks may also occur in a different order than the order marked in the drawings. For example, two consecutive blocks may actually be executed substantially in parallel, and they may sometimes be executed in a reverse order, depending on the functions involved. It should also be noted that each block in the block diagrams and/or flowcharts, and a combination of blocks in the block diagrams and/or flowcharts may be implemented by a dedicated hardware-based system that performs specified functions or actions, or may be implemented by a combination of dedicated hardware and computer instructions.

Embodiments of the present disclosure have been described above, and the above description is exemplary, not exhaustive, and is not limited to the disclosed embodiments. Many modifications and changes are obvious to ordinary technical personnel in this technical field without departing from the scope and spirit of the described embodiments. The selection of terms used in this article is intended to best explain the principles, practical applications or technical improvements of technologies in the market of the embodiments, or to enable other ordinary technical personnel in this technical field to understand the embodiments disclosed herein.

Some example implementations of the present disclosure are listed below.

Example 1. A method for determining similarity, including:
obtaining a first program statement and a second program statement;
generating a first heterogeneous diagram corresponding to the first program statement and a second heterogeneous diagram corresponding to the second program statement, the first heterogeneous diagram and the second heterogeneous diagram representing a plurality of statement tokens in the first program statement and the second program statement and relationships between the plurality of statement tokens, respectively; and
determining the similarity between the first program statement and the second program statement based on the first heterogeneous diagram and the second heterogeneous diagram.

Example 2. The method according to Example 1, where determining the first heterogeneous diagram includes:
determining the plurality of statement tokens in the first program statement and the relationships between the plurality of statement tokens by parsing the first program statement; and
determining a set of ordered operations based on an execution sequence of the first program statement; and
determining the first heterogeneous diagram based on the plurality of statement tokens, the relationships, and the set of ordered operations.

Example 3. The method according to Example 1-2, where at least one of the first program statement and the second program statement is a structured query language (SQL) statement.

Example 4. The method according to Example 1-3, where determining the similarity between the first program statement and the second program statement includes:
determining a first diagram embedding of the first heterogeneous diagram;
determining a second diagram embedding of the second heterogeneous diagram; and
determining the similarity based on the first diagram embedding and the second diagram embedding.

Example 5. The method according to Example 1-4, where determining the first diagram embedding of the first heterogeneous diagram includes:
determining a node embedding of a first-type node in the first heterogeneous diagram using a first encoder in a diagram matching model, where the first-type node is represented using one-hot encoding;
determining a node embedding of a second-type node in the first heterogeneous diagram using a second encoder in the diagram matching model, where the second-type node is represented using an ASCII code; and
generating the first diagram embedding based on the node embedding of the first-type node and the node embedding of the second-type node.

Example 6. The method according to Example 1-5, further including:
obtaining a first training program statement, a second training program statement, and a similarity label;
generating a first training heterogeneous diagram and a second training heterogeneous diagram;
determining a similarity prediction between the first training heterogeneous diagram and the second training heterogeneous diagram using the diagram matching model; and
adjusting the diagram matching model based on the similarity label and the similarity prediction.

Example 7. The method according to Example 1-6, where determining the similarity prediction using the diagram matching model includes:
determining a first training diagram embedding of the first training heterogeneous diagram;
determining a second training diagram embedding of the second training heterogeneous diagram; and
determining the similarity prediction based on the first training diagram embedding and the second training diagram embedding.

Example 8. The method according to Example 1-7, where determining the first training diagram embedding of the first training heterogeneous diagram includes:
aggregating node information in the first training heterogeneous diagram into a first node embedding based on a node structure in the first training heterogeneous diagram;
aggregating the node information in the first training heterogeneous diagram and node information in the second training heterogeneous diagram into a second node embedding based on a joint node structure of the first training heterogeneous diagram and the second training heterogeneous diagram;
updating a node embedding in the first training heterogeneous diagram based on the first node embedding and the second node embedding; and
determining the first training diagram embedding based on the node embedding in the first training heterogeneous diagram.

Example 9. The method according to Example 1-8, where aggregating the node information in the first training heterogeneous diagram and the node information in the second training heterogeneous diagram into the second node embedding includes:
generating a position encoding for each node by connecting a root node of the first training heterogeneous diagram and a root node of the second training heterogeneous diagram;
determining weight information for an attention mechanism based on the position encoding; and
aggregating the node information in the first training heterogeneous diagram and the node information in the second training heterogeneous diagram into the second node embedding based on the weight information and the position encoding.

Example 10. The method according to Example 1-9, where determining the first training diagram embedding includes:
determining the first training diagram embedding by aggregating the node embeddings in the first training heterogeneous diagram.

Example 11. An apparatus for determining similarity, including:
a statement obtaining unit configured to obtain a first program statement and a second program statement;
a heterogeneous diagram generation unit configured to generate a first heterogeneous diagram corresponding to the first program statement and a second heterogeneous diagram corresponding to the second program statement, the first heterogeneous diagram and the second heterogeneous diagram representing a plurality of statement tokens in the first program statement and the second program statement and relationships between the plurality of statement tokens, respectively; and
a similarity determination unit configured to determine the similarity between the first program statement and the second program statement based on the first heterogeneous diagram and the second heterogeneous diagram.

Example 12. The apparatus according to Example 11, where the heterogeneous diagram generation unit includes:
a first statement parsing unit configured to determine the plurality of statement tokens in the first program statement and the relationships between the plurality of statement tokens by parsing the first program statement; and
a first operation determination unit configured to determine a set of ordered operations based on an execution sequence of the first program statement; and
a first heterogeneous diagram determination unit configured to determine the first heterogeneous diagram based on the plurality of statement tokens, the relationships, and the set of ordered operations.

Example 13. The apparatus according to Example 11-12, where at least one of the first program statement and the second program statement is a structured query language (SQL) statement.

Example 14. The apparatus according to Example 11-13, where the similarity determination unit includes:
a first diagram embedding determination unit configured to determine a first diagram embedding of the first heterogeneous diagram;
a second diagram embedding determination unit configured to determine a second diagram embedding of the second heterogeneous diagram; and
a similarity second determination unit configured to determine the similarity based on the first diagram embedding and the first diagram embedding.

Example 15. The apparatus according to Example 11-14, where the first diagram embedding determination unit includes:
a first node embedding determination unit configured to determine a node embedding of a first-type node in the first heterogeneous diagram using a first encoder in a diagram matching model, where the first-type node is represented using one-hot encoding;
a second node embedding determination unit configured to determine a node embedding of a second-type node in the first heterogeneous diagram using a second encoder in the diagram matching model, where the second-type node is represented using an ASCII code; and
a first diagram embedding determination unit configured to generate the first diagram embedding based on the node embedding of the first-type node and the node embedding of the second-type node.

Example 16. The apparatus according to Example 11-15, further including:
a training data obtaining unit configured to obtain a first training program statement, a second training program statement, and a similarity label;
a training heterogeneous diagram generation unit configured to generate a first training heterogeneous diagram and a second training heterogeneous diagram;
a similarity prediction unit configured to determine a similarity prediction between the first training heterogeneous diagram and the second training heterogeneous diagram using the diagram matching model; and
a model adjustment unit configured to adjust the diagram matching model based on the similarity label and the similarity prediction.

Example 17. The apparatus according to Example 11-16, where the similarity prediction unit includes:
a first training diagram embedding determination unit configured to determine a first training diagram embedding of the first training heterogeneous diagram;
a second training diagram embedding determination unit configured to determine a second training diagram embedding of the second training heterogeneous diagram; and
a similarity prediction second determination unit configured to determine the similarity prediction based on the first training diagram embedding and the second training diagram embedding.

Example 18. The apparatus according to Example 11-17, where the first training diagram embedding determination unit includes:
a first node aggregation unit configured to aggregate node information in the first training heterogeneous diagram into a first node embedding based on a node structure in the first training heterogeneous diagram;
a second node aggregation unit configured to aggregate the node information in the first training heterogeneous diagram and node information in the second training heterogeneous diagram into a second node embedding based on a joint node structure of the first training heterogeneous diagram and the second training heterogeneous diagram;
a node embedding update unit configured to update a node embedding in the first training heterogeneous diagram based on the first node embedding and the second node embedding; and
a training diagram embedding second determination unit configured to determine the first training diagram embedding based on the node embedding in the first training heterogeneous diagram.

Example 19. The apparatus according to Example 11-12, where the second node aggregation unit includes:
a position encoding generation unit configured to generate a position encoding for each node by connecting a root node of the first training heterogeneous diagram and a root node of the second training heterogeneous diagram;
a weight information generation unit configured to determine weight information for an attention mechanism based on the position encoding; and
a second node second aggregation unit configured to aggregate the node information in the first training heterogeneous diagram and the node information in the second training heterogeneous diagram into the second node embedding based on the weight information and the position encoding.

Example 20. The apparatus according to Example 11-19, where the training diagram embedding second determination unit includes:
a training diagram embedding third determination unit configured to determine the first training diagram embedding by aggregating the node embeddings in the first training heterogeneous diagram.

Example 21. An electronic device, including:
a processor; and
a memory coupled to the processor, the memory having instructions stored therein, the instructions, when executed by the processor, causing the electronic device to perform an action, the action including:

Example 22. The electronic device according to Example 21, where determining the first heterogeneous diagram includes:
determining the plurality of statement tokens in the first program statement and the relationships between the plurality of statement tokens by parsing the first program statement;
determining a set of ordered operations based on an execution sequence of the first program statement; and
determining the first heterogeneous diagram based on the plurality of statement tokens, the relationships, and the set of ordered operations.

Example 23. The electronic device according to Example 21-22, where at least one of the first program statement and the second program statement is a structured query language (SQL) statement.

Example 24. The electronic device according to Example 21-23, where determining the similarity between the first program statement and the second program statement includes:
determining a first diagram embedding of the first heterogeneous diagram;
determining a second diagram embedding of the second heterogeneous diagram; and
determining the similarity based on the first diagram embedding and the second diagram embedding.

Example 25. The electronic device according to Example 21-24, where determining the first diagram embedding of the first heterogeneous diagram includes:
determining a node embedding of a first-type node in the first heterogeneous diagram using a first encoder in a diagram matching model, where the first-type node is represented using one-hot encoding;
determining a node embedding of a second-type node in the first heterogeneous diagram using a second encoder in the diagram matching model, where the second-type node is represented using an ASCII code; and
generating the first diagram embedding based on the node embedding of the first-type node and the node embedding of the second-type node.

Example 26. The electronic device according to Example 21-25, the action further including:
obtaining a first training program statement, a second training program statement, and a similarity label;
generating a first training heterogeneous diagram and a second training heterogeneous diagram;
determining a similarity prediction between the first training heterogeneous diagram and the second training heterogeneous diagram using the diagram matching model; and
adjusting the diagram matching model based on the similarity label and the similarity prediction.

Example 27. The electronic device according to Example 21-26, where determining the similarity prediction using the diagram matching model includes:
determining a first training diagram embedding of the first training heterogeneous diagram;
determining a second training diagram embedding of the second training heterogeneous diagram; and
determining the similarity prediction based on the first training diagram embedding and the second training diagram embedding.

Example 28. The electronic device according to Example 21-27, where determining the first training diagram embedding of the first training heterogeneous diagram includes:
aggregating node information in the first training heterogeneous diagram into a first node embedding based on a node structure in the first training heterogeneous diagram;
aggregating the node information in the first training heterogeneous diagram and node information in the second training heterogeneous diagram into a second node embedding based on a joint node structure of the first training heterogeneous diagram and the second training heterogeneous diagram;
updating a node embedding in the first training heterogeneous diagram based on the first node embedding and the second node embedding; and
determining the first training diagram embedding based on the node embedding in the first training heterogeneous diagram.

Example 29. The electronic device according to Example 21-28, where aggregating the node information in the first training heterogeneous diagram and the node information in the second training heterogeneous diagram into the second node embedding includes:
generating a position encoding for each node by connecting a root node of the first training heterogeneous diagram and a root node of the second training heterogeneous diagram;
determining weight information for an attention mechanism based on the position encoding; and
aggregating the node information in the first training heterogeneous diagram and the node information in the second training heterogeneous diagram into the second node embedding based on the weight information and the position encoding.

Example 30. The electronic device according to Example 21-29, where determining the first training diagram embedding includes:
determining the first training diagram embedding by aggregating the node embeddings in the first training heterogeneous diagram.

Example 31. A computer-readable storage medium having one or more computer instructions stored thereon, where the one or more computer instructions are executed by a processor to implement the method according to any one of Examples 1 to 10.

Example 32. A computer program product being tangibly stored on a computer-readable medium and including computer-executable instructions, the computer-executable instructions, when executed by a device, causing the device to perform the method according to any one of Examples 1 to 10.

Although the present disclosure has been described in language specific to structural features and/or logical actions of methods, it should be understood that the subject matter defined in the appended claims is not necessarily limited to the specific features or actions described above. Rather, the specific features and actions described above are merely example forms for implementing the claims.

I/We claim:

1. A method for determining similarity, comprising:
obtaining a first program statement and a second program statement;
generating a first heterogeneous diagram corresponding to the first program statement and a second heterogeneous diagram corresponding to the second program statement, the first heterogeneous diagram and the second heterogeneous diagram representing a plurality of statement tokens and relationships between the plurality of statement tokens in the first program statement and the second program statement, respectively; and
determining the similarity between the first program statement and the second program statement based on the first heterogeneous diagram and the second heterogeneous diagram.

2. The method according to claim 1, wherein determining the first heterogeneous diagram comprises:
determining the plurality of statement tokens in the first program statement and the relationships between the plurality of statement tokens by parsing the first program statement;
determining a set of ordered operations based on an execution order of the first program statement; and
determining the first heterogeneous diagram based on the plurality of statement tokens, the relationships, and the set of ordered operations.

3. The method according to claim 1, wherein at least one of the first program statement and the second program statement comprises a structured query language (SQL) statement.

4. The method according to claim 1, wherein determining the similarity between the first program statement and the second program statement comprises:
determining a first diagram embedding of the first heterogeneous diagram;
determining a second diagram embedding of the second heterogeneous diagram; and
determining the similarity based on the first diagram embedding and the second diagram embedding.

5. The method according to claim 4, wherein determining the first diagram embedding of the first heterogeneous diagram comprises:
determining a node embedding of a first-type node in the first heterogeneous diagram using a first encoder in a diagram matching model, wherein the first-type node is represented using one-hot encoding;
determining a node embedding of a second-type node in the first heterogeneous diagram using a second encoder in the diagram matching model, wherein the second-type node is represented using an ASCII code; and
generating the first diagram embedding based on the node embedding of the first-type node and the node embedding of the second-type node.

6. The method according to claim 5, further comprising:
obtaining a first training program statement, a second training program statement, and a similarity label;
generating a first training heterogeneous diagram and a second training heterogeneous diagram;
determining, using the diagram matching model, a similarity prediction between the first training heterogeneous diagram and the second training heterogeneous diagram; and
adjusting the diagram matching model based on the similarity label and the similarity prediction.

7. The method according to claim 6, wherein determining the similarity prediction using the diagram matching model comprises:
determining a first training diagram embedding of the first training heterogeneous diagram;
determining a second training diagram embedding of the second training heterogeneous diagram; and
determining the similarity prediction based on the first training diagram embedding and the second training diagram embedding.

8. The method according to claim 7, wherein determining the first training diagram embedding of the first training heterogeneous diagram comprises:
aggregating node information in the first training heterogeneous diagram into a first node embedding based on a node structure in the first training heterogeneous diagram;
aggregating the node information in the first training heterogeneous diagram and node information in the second training heterogeneous diagram into a second node embedding based on a joint node structure of the first training heterogeneous diagram and the second training heterogeneous diagram;
updating a node embedding in the first training heterogeneous diagram based on the first node embedding and the second node embedding; and
determining the first training diagram embedding based on the node embedding in the first training heterogeneous diagram.

9. The method according to claim 8, wherein aggregating the node information in the first training heterogeneous diagram and the node information in the second training heterogeneous diagram into the second node embedding comprises:
generating a position encoding for each node by connecting a root node of the first training heterogeneous diagram and a root node of the second training heterogeneous diagram;
determining weight information for attention mechanism based on the position encoding; and
aggregating the node information in the first training heterogeneous diagram and the node information in the second training heterogeneous diagram into the second node embedding based on the weight information and the position encoding.

10. The method according to claim 8, wherein determining the first training diagram embedding comprises:
determining the first training diagram embedding by aggregating the node embeddings in the first training heterogeneous diagram.

11. An electronic device, comprising:
one or more processors;
a storage device for storing one or more programs, wherein,
the one or more programs, when executed by the one or more processors, cause the one or more processors to:
obtain a first program statement and a second program statement;
generate a first heterogeneous diagram corresponding to the first program statement and a second heterogeneous diagram corresponding to the second program statement, the first heterogeneous diagram and the second heterogeneous diagram representing a plurality of statement tokens and relationships between the plurality of statement tokens in the first program statement and the second program statement, respectively; and
determine the similarity between the first program statement and the second program statement based on the first heterogeneous diagram and the second heterogeneous diagram.

12. The device according to claim 11, wherein the one or more processors causing the one or more processors to determine the first heterogeneous diagram comprise instructions to:
determine the plurality of statement tokens in the first program statement and the relationships between the plurality of statement tokens by parsing the first program statement;
determine a set of ordered operations based on an execution order of the first program statement; and
determine the first heterogeneous diagram based on the plurality of statement tokens, the relationships, and the set of ordered operations.

13. The device according to claim 11, wherein at least one of the first program statement and the second program statement comprises a structured query language (SQL) statement.

14. The device according to claim 11, wherein the one or more processors causing the one or more processors to determine the similarity between the first program statement and the second program statement comprise instructions to:
determine a first diagram embedding of the first heterogeneous diagram;
determine a second diagram embedding of the second heterogeneous diagram; and
determine the similarity based on the first diagram embedding and the second diagram embedding.

15. The device according to claim 14, wherein determining the first diagram embedding of the first heterogeneous diagram comprises:
determining a node embedding of a first-type node in the first heterogeneous diagram using a first encoder in a diagram matching model, wherein the first-type node is represented using one-hot encoding;
determining a node embedding of a second-type node in the first heterogeneous diagram using a second encoder in the diagram matching model, wherein the second-type node is represented using an ASCII code; and
generating the first diagram embedding based on the node embedding of the first-type node and the node embedding of the second-type node.

16. The device according to claim 15, wherein the one or more processors further cause the one or more processors to:
obtain a first training program statement, a second training program statement, and a similarity label;
generate a first training heterogeneous diagram and a second training heterogeneous diagram;
determine, using the diagram matching model, a similarity prediction between the first training heterogeneous diagram and the second training heterogeneous diagram; and
adjust the diagram matching model based on the similarity label and the similarity prediction.

17. The device according to claim 16, wherein determining the similarity prediction using the diagram matching model comprises:
determining a first training diagram embedding of the first training heterogeneous diagram;
determining a second training diagram embedding of the second training heterogeneous diagram; and
determining the similarity prediction based on the first training diagram embedding and the second training diagram embedding.

18. The device according to claim 17, wherein determining the first training diagram embedding of the first training heterogeneous diagram comprises:
aggregating node information in the first training heterogeneous diagram into a first node embedding based on a node structure in the first training heterogeneous diagram;
aggregating the node information in the first training heterogeneous diagram and node information in the second training heterogeneous diagram into a second node embedding based on a joint node structure of the first training heterogeneous diagram and the second training heterogeneous diagram;
updating a node embedding in the first training heterogeneous diagram based on the first node embedding and the second node embedding; and
determining the first training diagram embedding based on the node embedding in the first training heterogeneous diagram.

19. The device according to claim 18, wherein aggregating the node information in the first training heterogeneous diagram and the node information in the second training heterogeneous diagram into the second node embedding comprises:
generating a position encoding for each node by connecting a root node of the first training heterogeneous diagram and a root node of the second training heterogeneous diagram;
determining weight information for attention mechanism based on the position encoding; and
aggregating the node information in the first training heterogeneous diagram and the node information in the second training heterogeneous diagram into the second node embedding based on the weight information and the position encoding.

20. A non-transitory storage medium containing computer-executable instructions, wherein the computer-executable instructions, when executed by one or more computer processors, are used to cause the one or more computer processors to:
obtain a first program statement and a second program statement;
generate a first heterogeneous diagram corresponding to the first program statement and a second heterogeneous diagram corresponding to the second program statement, the first heterogeneous diagram and the second heterogeneous diagram representing a plurality of statement tokens and relationships between the plurality of statement tokens in the first program statement and the second program statement, respectively; and
determine the similarity between the first program statement and the second program statement based on the first heterogeneous diagram and the second heterogeneous diagram.
